(19) United States
(12) Patent Application Publication
(10) Pub. No.: US 2024/0316934 A1
(43) Pub. Date: Sep. 26, 2024

(54) WIPING DEVICE AND LIQUID DISCHARGE APPARATUS

(71) Applicant: Kenta TAKAHASHI, Kanagawa (JP)

(72) Inventor: Kenta TAKAHASHI, Kanagawa (JP)

(73) Assignee: Ricoh Company, Ltd., Tokyo (JP)

(21) Appl. No.: 18/431,105

(22) Filed: Feb. 2, 2024

(30) Foreign Application Priority Data
Mar. 24, 2023 (JP) 2023-048087

(51) Int. Cl. B41J 2/165; B41J 29/17

(52) U.S. Cl. CPC B41J 2/16535; B41J 29/17; B41J 2002/1655; B41P 2235/242; B41P 2235/244; B41P 2235/246

(57) ABSTRACT

A wiping device includes a windable web and a blade, and wipes out a nozzle surface provided on a liquid discharge head and including a plurality of nozzle holes. The wiping device wipes out the nozzle surface by at least the web when there is a remaining amount of the web, and wipes out the nozzle surface by the blade when there is not the remaining amount of the web.

### CROSS-REFERENCE TO RELATED APPLICATIONS

The present application claims priority under 35 U.S.C. § 119 to Japanese Patent Application No. 2023-048087 filed on Mar. 24, 2023. The contents of which are incorporated herein by reference in their entirety.

### BACKGROUND OF THE INVENTION

### 1. Field of the Invention

The present invention relates to wiping devices and liquid discharge apparatuses.

### 2. Description of the Related Art

Conventionally, there has been a wiping device that includes a wiping member configured to wipe out liquid remaining on a nozzle surface of a liquid discharge head. Such the wiping device may have a configuration of wiping out the nozzle surface with a rubber blade having low water absorption.

However, in such the wiping by the blade, depending on liquid discharged from the liquid discharge head, the liquid thickens or dries to become deposited on the blade when wiping. Performing a wiping operation in this state results in degrading the cleanability of the nozzle surface and pushing the deposited liquid into a nozzle, and consequently leading to the poor discharge of the liquid discharge head.

For example, a wiping device disclosed in Japanese Unexamined Patent Application Publication No. 2019-162862 includes a windable web as a member for wiping out a nozzle surface, separately from a rubber wiper having low water absorption. The web is shaped like a sheet with water absorption. In the wiping device, a wiping member to be used depending on a mode is changed.

In a windable wiping member, it is necessary to exchange the wiping member when the wiping member is completely wound to be an end state. However, when a new windable wiping member cannot be prepared, there was a problem that a wiping operation by the wiping member cannot be executed.

### SUMMARY OF THE INVENTION

According to one aspect of the present invention, a wiping device includes a windable first wiping member and a second wiping member, and wipes out a nozzle surface provided on a liquid discharge head and including a plurality of nozzle holes. The wiping device wipes out the nozzle surface by at least the first wiping member when there is a remaining amount of the first wiping member, and wipes out the nozzle surface by the second wiping member when there is not the remaining amount of the first wiping member.

### BRIEF DESCRIPTION OF THE DRAWINGS

FIG. 1 is a schematic configuration diagram illustrating a wiping device according to one embodiment of the present invention;

FIG. 2 is a diagram explaining a state of a web cartridge during a second wiping operation;

FIG. 3 is a flowchart illustrating a procedure during a wiping maintenance operation by the wiping device;

FIG. 4 is a flowchart illustrating a procedure during a printing operation by the wiping device;

FIG. 5 is a flowchart illustrating a procedure during a web cartridge exchange by the wiping device;

FIG. 6 is a schematic configuration diagram illustrating the wiping device in which a blade is provided separately from the web cartridge;

FIG. 7 is a diagram explaining a state where the wiping device of FIG. 6 wipes out a nozzle surface by the blade;

FIG. 8 is a flowchart illustrating a procedure during a wiping maintenance operation according to an embodiment in which the number of usages of the blade is limited;

FIG. 9 is a flowchart illustrating a procedure during a printing operation by the wiping device according to the embodiment of FIG. 8;

FIG. 10 is a flowchart illustrating a procedure during a web cartridge exchange by the wiping device according to the embodiment of FIG. 8;

FIG. 11 is a flowchart illustrating a procedure during a wiping maintenance operation according to another embodiment in which the number of usages of the blade is limited;

FIG. 12 is a flowchart illustrating a procedure during a web cartridge exchange by the wiping device according to the embodiment of FIG. 11;

FIG. 13 is a flowchart illustrating a procedure during a wiping maintenance operation in the wiping device including a cleaning mechanism;

FIG. 14 is a schematic view illustrating the cleaning mechanism;

FIG. 15 is a plan view illustrating a liquid discharge apparatus;

FIG. 16 is a side view illustrating the liquid discharge apparatus;

FIG. 17 is a bottom view illustrating a liquid discharge head;

FIG. 18 is a control block diagram illustrating the liquid discharge apparatus;

FIG. 19 is a functional block diagram illustrating the liquid discharge apparatus and the wiping device;

FIG. 20 is a perspective view illustrating an example of a liquid discharge apparatus according to one embodiment of the present invention;

FIG. 21 is a plan view illustrating the liquid discharge apparatus of FIG. 20;

FIG. 22 is a perspective view illustrating a state where each cover member of the liquid discharge apparatus of FIG. 20 is opened;

FIG. 23 is a plan view illustrating the liquid discharge apparatus of FIG. 22; and

FIG. 24 is a diagram illustrating a configuration that two liquid discharge head units are provided in one carriage.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described in detail below with reference to the accompanying drawings. Note that the same or corresponding parts in each drawing have the same reference numbers and overlapping explanations are appropriately simplified or omitted.

An object of embodiments is to provide a wiping device including a windable wiping member that is capable of increasing the continuity of a wiping operation.

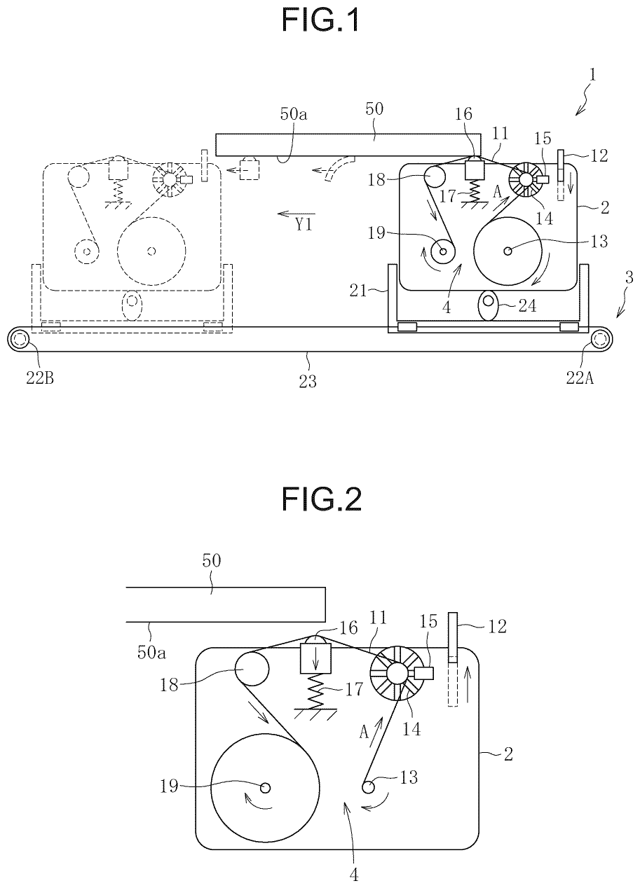

As illustrated in FIG. 1, a wiping device 1 includes a web cartridge 2 acting as a wiping unit and a moving mechanism 3. The web cartridge 2 is provided on an upper side of the moving mechanism 3. The wiping device 1 is a device that wipes out a nozzle surface 50a of a liquid discharge head 50. A plurality of nozzle holes is provided on the nozzle surface 50a, and ink as liquid is discharged from the nozzle holes. The liquid discharge head 50 is provided in a liquid discharge apparatus that prints an image on a recording medium such as paper.

The web cartridge 2 includes a first wiping mechanism 4 and a blade 12 that is a second wiping member. The first wiping mechanism 4 includes a web 11 that is a windable first wiping member, a feeding roller 13, an encoder 14, a photo sensor 15, a pressing member 16, a spring 17, a conveying roller 18, and a winding roller 19 that is a winding mechanism. The second wiping member is not limited to the blade 12 according to the present embodiment, and may be an absorber, such as sponge, which absorbs liquid. Moreover, the second wiping member is not limited to a non-windable wiping member, and may be a windable wiping member such as the first wiping member.

The web cartridge 2 is provided to be detachable from the wiping device 1. By the attachment/detachment operation, the web cartridge 2 and “the web 11 and the blade 12” provided in the web cartridge 2 can be exchanged to new components.

The web 11 has water absorption. Thus, the web has at least liquid resistance with reference to liquid to be used and is preferably made of sheet-like material that does not generate fluff or dust, and includes non-woven fabric, cloth, film, paper, etc., for example.

The blade 12 is a member that has thickness and whose cross section has a rectangular shape. The blade 12 is preferably made of material that has at least water absorption lower than the web 11 and has elasticity, and includes rubber, soft resin, etc., for example, and can employ other materials such as Mylar and sponge. In this regard, however, the shape and configuration of the second wiping member are not limited to this. The blade 12 is attached to a housing of the web cartridge 2 so as to be vertically movable. The blade 12 is arranged on the upper stream side than the opposed position to the pressing member 16 of the web 11 with reference to a wiping direction Y1 by the web cartridge 2.

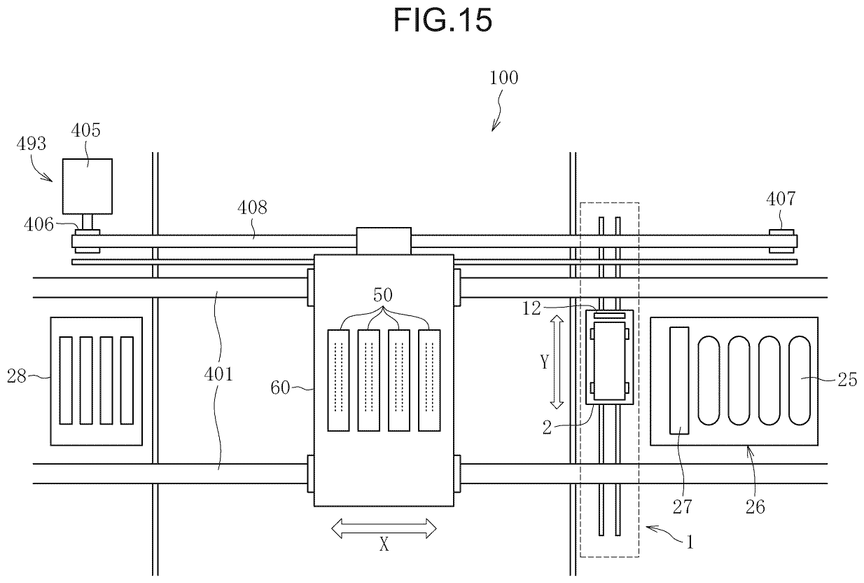

The wiping direction Y1 and the opposite direction (double-headed arrow Y direction illustrated in FIG. 15) are a sub-scanning direction in the liquid discharge apparatus or the conveyance direction and the opposite direction of the recording medium. Moreover, the direction X of FIG. 15 that is a direction orthogonal to these directions and is a direction along the surface of the recording medium onto which liquid is discharged is a main-scanning direction. Moreover, the up-down direction of FIG. 1 that is a direction orthogonal to the direction X and direction Y is the approach/separation direction with respect to the nozzle surface 50a of the web cartridge 2, and is the discharge direction and the opposite direction of liquid by the liquid discharge head. In the present embodiment, these directions are directions orthogonal to each other, but may have a margin of error.

As illustrated in FIG. 1, the feeding roller 13, the roller part of the encoder 14, the conveying roller 18, and the winding roller 19 are rotatably held in the housing part of the web cartridge 2. The web 11 is fed out from the feeding roller 13 in an arrow A direction by the rotation of the winding roller 19, and is wound up by the winding roller 19 through the roller part of the encoder 14 and the conveying roller 18. When the web cartridge 2 is attached to the wiping device 1, a gear connected to the winding roller 19 is connected to a transfer mechanism on the wiping device side. Thus, a driving force can be transmitted from a winding motor provided in the wiping device 1 to the winding roller 19.

The encoder 14 is provided with a plurality of detected parts at intervals in the rotation direction of the roller part. The detection state of the photo sensor 15 changes based on whether the detected parts are arranged at positions facing the photo sensor 15. A winding amount that is a feeding amount of the web 11 can be detected by a change in the detection state of the photo sensor 15 by the rotation of the encoder 14. Thus, a remaining amount of the web 11 can be detected. As described above, the encoder 14 and the photo sensor 15 constitute a remaining amount detection mechanism that detects a remaining amount of the web 11. The remaining amount detection mechanism can be configured as a transmissive optical sensor or a reflective optical sensor. Moreover, the mechanism may be a push-button detection sensor of depressing a button, a magnetic sensor, etc.

The pressing member 16 is biased by the spring 17, and presses the web 11 toward the nozzle surface 50a between the encoder 14 and the conveying roller 18. Thus, the web 11 is pressed against the nozzle surface 50a with a predetermined pressure. This pressing position is a wiping position at which the web 11 abuts on the nozzle surface 50a and wipes out the nozzle surface 50a.

The moving mechanism 3 can reciprocate the web cartridge 2 in the wiping direction Y1 and the opposite direction, and can move the web cartridge 2 in the approach/separation direction with respect to the nozzle surface 50a that is the up-down direction of FIG. 1.

The moving mechanism 3 includes a moving member 21, moving pulleys 22A and 22B, a timing belt 23, and a cam 24. The moving member 21 is movably provided on the timing belt 23, and can move the web cartridge 2 in the wiping direction Y1 and the opposite direction by this movement. One of the moving pulleys 22A and 22B transmits a driving force by a moving motor to be able to be rotated in both forward and reverse directions. By the rotation, the other of the moving pulleys 22A and 22B to which the driving force is transmitted via the timing belt 23 is drivenly rotated, and thus the timing belt 23 travels in circles. By the circular traveling, the moving member 21 can be moved in the wiping direction Y1 and the opposite direction. In this regard, however, the moving member 21 can be moved by an appropriate mechanism, and may be moved by a rack-and-pinion gear, for example.

The web cartridge 2 is arranged over the moving member 21 via the cam 24. The cam 24 is rotated by receiving a driving force by a cam motor. By this rotation, the web cartridge 2 can be moved up and down.

Next, a wiping operation of the nozzle surface 50a by the wiping device 1 will be described.

First, the web cartridge 2 upward moves by the rotation of the cam 24, and is arranged at the position of FIG. 1 where the wiping operation by the web 11 and the blade 12 is possible. Thus, the web 11 is pressed by the pressing member 16 to contact the nozzle surface 50a. In this state, the moving member 21 moves in the wiping direction Y1, and thus ink remaining on the nozzle surface 50a is wiped out and absorbed by the web 11 along the wiping direction Y1 to be removed. Moreover, the blade 12 arranged upstream of the wiping direction Y1 is pressed against the nozzle surface 50a, and the wiping operation by the blade 12 is performed. The web cartridge 2 eventually moves up to a dotted line position of FIG. 1, and the wiping operation for the nozzle surface 50a is terminated. Note that the web 11 and the blade 12 have a constant width in the main-scanning direction that is a direction orthogonal to the paper surface of FIG. 1.

After that or before the next wiping operation, the winding roller 19 is rotated by the winding motor, and the web 11 is wound up by a predetermined amount. Thus, the unused web 11 is arranged on the pressing member 16, and the next wiping operation by the web 11 is in a possible state. In this regard, however, the wiping operation for the nozzle surface 50a may be performed while winding up the web 11.

By winding up the web 11 by the winding roller 19 as described above, the web 11 held on the feeding roller 13 is reduced, and eventually the unused web 11 cannot be arranged on the pressing member 16. Alternatively, the further winding of the web 11 by the winding roller 19 (winding member) cannot be performed. Moreover, in the embodiment that performs the wiping operation for the nozzle surface 50a while winding up the web 11, it is in a state where there is not even the web 11 that can perform one wiping operation. These states are “a state without a remaining amount” of the web 11 that is a windable wiping member. Hereinafter, this state is referred to as an end state of the web 11.

For example, the detection of the end state can be determined as an end state when the rotation load of the winding roller 19 is a predetermined value or more. Alternatively, a feed amount of the web 11 is soft-counted by a remaining amount detection mechanism, and the end state may be determined by the soft-count. In particular, in the embodiment that performs the wiping operation for the nozzle surface 50a while winding up the above web 11, whether the present state is the end state is detected by the soft-count.

Moreover, in the above description, the case (hereinafter, referred to as first wiping operation) where the wiping operation for the nozzle surface 50a is performed by both of the web 11 and the blade 12 is illustrated, but the present embodiment is not limited to the above. For example, the blade 12 of FIG. 1 can be moved downward to be moved up to the dotted line position. By performing the wiping operation in this state, the blade 12 is not be in contact with the nozzle surface 50a, and the nozzle surface 50a can be wiped out by only the web 11 (hereinafter, referred to as third wiping operation).

Moreover, as illustrated in FIG. 2, by moving the web cartridge 2 lower than FIG. 1, the web 11 at the pressing position of the pressing member 16 can be arranged at the height at which the web does not contact the nozzle surface 50a. Moreover, in this state, as illustrated in FIG. 2, the blade 12 is further upward moved from the position of FIG. 1. Thus, the wiping operation by only the blade 12 can be performed (hereinafter, referred to as second wiping operation).

In the case of a wiping member such as the blade 12 having low water absorption, liquid such as ink becomes deposited on the blade 12 during wiping the nozzle surface 50a. Then, by performing the wiping operation in this state, there was a problem that the cleanability of the nozzle surface 50a is degraded and the deposited ink is pushed into the nozzle. On the contrary, good wiping performance on the nozzle surface 50a can be obtained by wiping out the nozzle surface 50a by the wiping member such as the windable web 11 having high water absorption. Moreover, by performing the winding for each wiping operation, the wiping operation can be constantly executed by using the unused web 11, and thus the decrease in the wiping performance by the repeated use as in the case of the blade 12 does not occur. However, on the other hand, in the windable wiping member such as the web 11 having high water absorption, it is necessary to exchange the web cartridge 2 with a new one when the web 11 reaches the end state.

In this regard, unlike with the present embodiment, when the wiping device has only the windable wiping member such as the web 11 and when the web cartridge 2 cannot be exchanged with a new web cartridge immediately after the web 11 reaches the end state, there was a problem that the wiping operation of the nozzle surface 50a cannot be executed and thus ink clogging occurs in the nozzle. Moreover, when the wiping operation cannot be executed, there was a problem that a machine operation including a printing operation of the liquid discharge apparatus that includes a liquid discharge head cannot be executed. Furthermore, when the web reaches the end state during the printing operation, there was a problem that printing stops in the middle. For this reason, when an operator instructs the liquid discharge apparatus to perform mass printing and then has left it at it is, for example, the operator may not notice the stop of printing even if printing stops in the middle, and thus a response at the early timing such as the exchange with a new web cartridge is required when a remaining amount of the web becomes small.

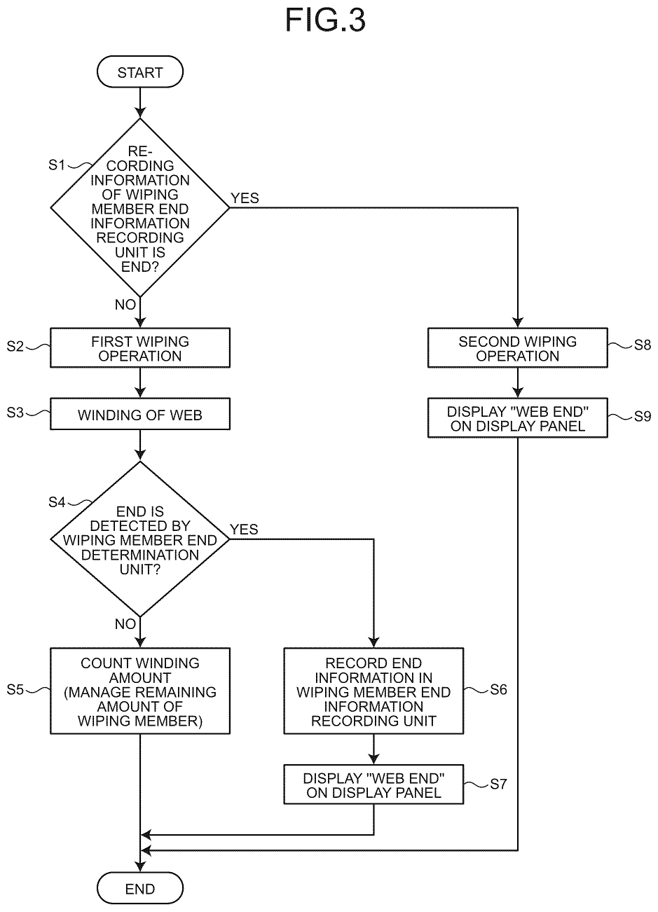

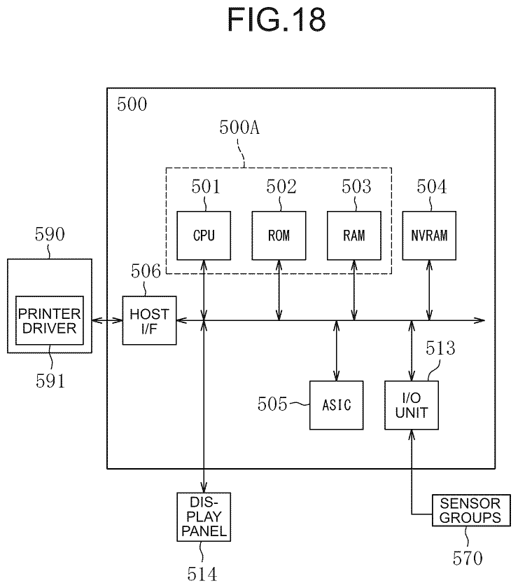

Hereinafter, the wiping operation according to the present embodiment of solving the problem will be described. First, a procedure when the wiping maintenance is executed will be described with reference to a flowchart illustrated in FIG. 3. Note that control for each operation such as the wiping maintenance is performed by a control unit provided on the main body side of the liquid discharge apparatus with reference to information recorded in a recording unit such as a wiping member end information recording unit and a wiping member remaining-amount recording unit provided in the web cartridge 2 (see FIG. 18). A detailed configuration of the control unit will be described later.

First, whether the recording information of the wiping member end information recording unit is the end, that is, whether the web 11 reaches the end state is determined (Step S1). In the case of NO, because the remaining amount of the web 11 remains, the first wiping operation is performed by the web 11 and the blade 12 (Step S2). In this regard, however, the third wiping operation may be performed by only the web 11.

After that, the winding operation of the web 11 is performed (Step S3), and whether the present state is the end state is detected by a wiping member end determination unit of a wiping control unit provided on the liquid discharge apparatus side (Step S4). When the end state is not detected, a winding amount, that is, a remaining amount of the web is counted (Step S5). On the other hand, when the end state is detected, end information is recorded in the wiping member end information recording unit (Step S6), and “web end” is displayed on a display panel provided in the liquid discharge apparatus (Step S7). This web end is display indicating the end state of the windable first wiping member. This display allows an operator to urge the operator to exchange the web cartridge 2.

Moreover, in the present embodiment, when the present state is the end state in Step S1, the second wiping operation is performed (Step S8). In other words, the wiping operation is performed by only the blade 12. Then, “web end” is displayed on the display panel (Step S9). Note that, in the conventional wiping device not having the second wiping member or not having an urgent wiping operation mode by the second wiping member in the end state of the first wiping member, the apparatus stops in this step and thus the wiping operation and the printing operation after that cannot be performed.

In the present embodiment as described above, when there is not the remaining amount of the web 11 that is the windable first wiping member, the wiping operation is executed by the blade 12 that is the second wiping member. Therefore, the nozzle surface 50a is wiped out by the windable first wiping member to obtain good wipeability in normal times, and a trouble can be prevented that the wiping maintenance as described above cannot be executed or the apparatus stops due to the un-preparation of the new web 11. In other words, even if the configuration employs the windable first wiping member, the continuity of the wiping operation by the wiping device can be increased. In particular, by using the non-windable wiping member having water absorption smaller than the windable first wiping member as the second wiping member, because the repeated use is possible without reaching the end state even when using up the windable wiping member, the second wiping member is preferable as a preliminary wiping member. Moreover, because the large-scale configuration such as the windable type is not needed, the second wiping member is preferable as a preliminary wiping member even in this regard.

Like the present embodiment, it is preferable that the configuration of using the windable first wiping member having high water absorption as the first wiping member is applied to the liquid discharge apparatus that discharges liquid such as ink having high deposition and drying properties especially.

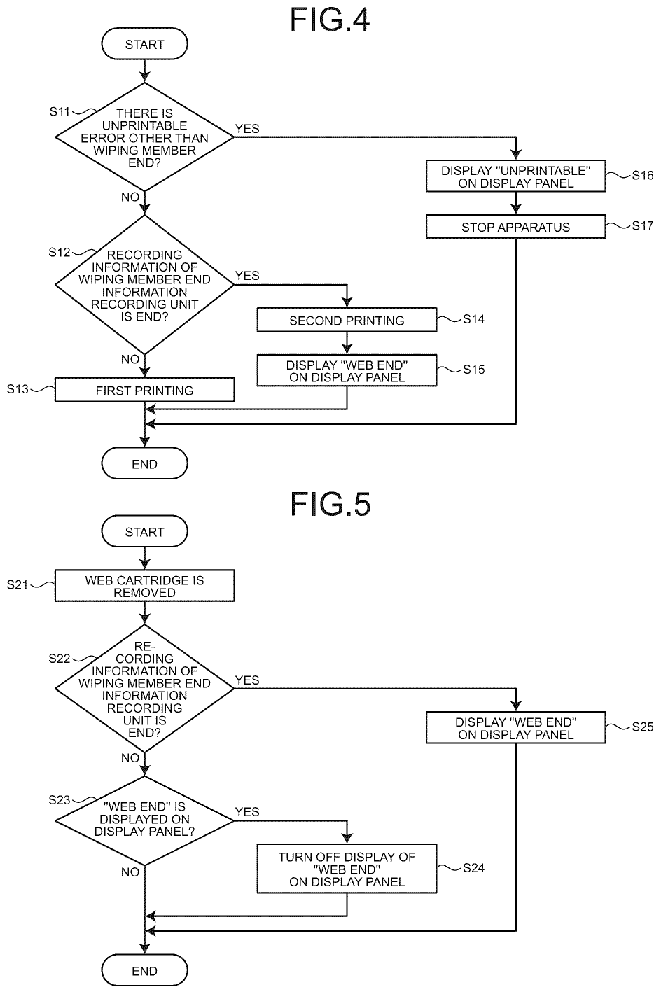

Next, a procedure for the wiping operation during the printing operation will be described with reference to a flowchart illustrated in FIG. 4.

When the printing operation is started, whether there is an unprintable error other than the wiping member end is determined by the control unit provided in the liquid discharge apparatus (Step S11). In the presence of the unprintable error, “unprintable” is displayed on the display panel and then the liquid discharge apparatus is stopped (Steps S16 and S17).

On the other hand, in the absence of the unprintable error, whether the end state is recorded in the wiping member end information recording unit is determined (Step S12). When the present state is not the end state, first printing is performed (Step S13). The first printing is a print mode of performing the first wiping operation or the third wiping operation as an automatic maintenance of the nozzle surface 50a. Moreover, when the present state is the end state, second printing is performed and “web end” is displayed on the display panel (Steps S14 and S15). The second printing is a print mode of performing the second wiping operation as an automatic maintenance of the nozzle surface 50a. As described above, even in the wiping operation for the nozzle surface 50a during the printing operation, the second wiping operation by the blade 12 can be executed when the web 11 is in the end state. Therefore, the printing stop by the end state of the web 11 can be prevented.

FIG. 5 is a flowchart illustrating a determination procedure when the web cartridge 2 is exchanged.

When the web cartridge 2 is removed (Step S21), it is determined whether the end state is recorded in the wiping member end information recording unit of the web cartridge 2 after the exchange (Step S22). When the present state is not the end state, the display is turned off if “web end” is displayed on the display panel (Steps S23 and S24).

On the other hand, when the present state is the end state, “web end” is displayed on the display panel and the procedure is terminated (Step S25). In the present embodiment as described above, the second wiping operation is possible and thus the liquid discharge apparatus is not stopped, even if the present state is the end state temporarily.

Like the present embodiment, it is preferable that the blade 12 is provided integrally with the web 11 and the web cartridge has a configuration that they can be exchanged together. In other words, when the blade 12 repeats the wiping operation, ink becomes deposited on its surface to decrease the wiping performance and thus the poor discharge of the liquid discharge head occurs. On the contrary, by providing the blade 12 integrally with the web 11, the blade 12 can be also exchanged with a new one at a timing at which the web 11 reaches the end state and is exchanged. Therefore, even if the blade 12 is not cleaned by the operator temporarily, the good state of the blade 12 can be maintained, and the decrease in the wiping performance of the blade 12 due to deposition of ink, pretreatment liquid, etc. onto the blade 12 can be suppressed.

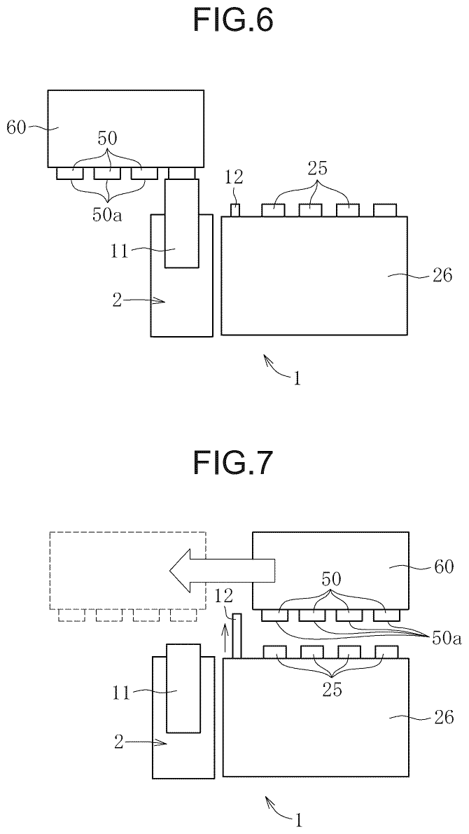

In this regard, however, the present invention is not limited to the configuration integrally including the first wiping member and the second wiping member. For example, the wiping device 1 illustrated in FIG. 6 includes the blade 12 separately from the web cartridge 2 including the web 11. The blade 12 is provided on a maintenance unit 26 that includes caps 25 for covering nozzle surfaces 50a, for example. The wiping device 1 wipes out the nozzle surfaces 50a of a plurality of liquid discharge heads 50 included in a carriage 60.

When performing the wiping operation by the web 11, the web cartridge 2 is moved in the wiping direction that is a direction orthogonal to the paper surface of FIG. 6 in a state where the web 11 is in contact with the nozzle surfaces 50a, like the above described embodiment. Moreover, as illustrated in FIG. 7, when performing the wiping operation by the blade 12, the web 11 is moved downward from FIG. 6 to evacuate from the nozzle surface 50a and the blade 12 is upward from FIG. 6 to be arranged at a position where the blade can contact the nozzle surface 50a. In this state, by moving the carriage 60 in the main-scanning direction that is a left-right direction of FIG. 7, the nozzle surface 50a of each of the liquid discharge heads 50 can wiped out by the blade 12. In this regard, however, similarly to the case of the web 11, the maintenance unit may have a configuration of wiping out the nozzle surfaces 50a by moving the blade 12 in a direction orthogonal to the paper surface of FIG. 7.

In the present embodiment, the number of parts of the web cartridge 2 can be reduced and a cost of the web cartridge 2 can be reduced. On the other hand, to prevent the decrease in the wiping performance of the blade 12, it is desirable to clean the blade 12 periodically.

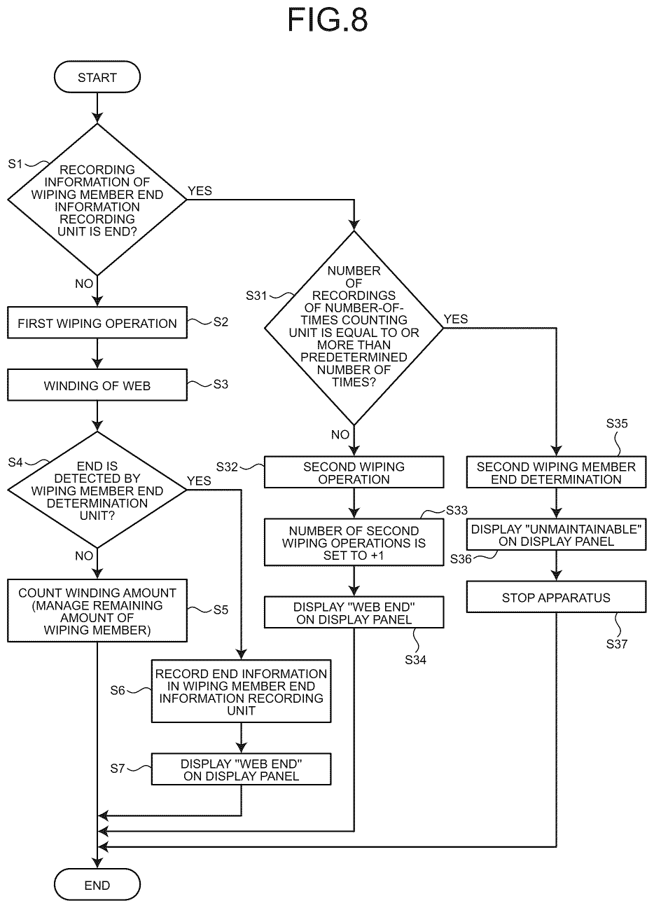

Next, in the wiping device 1 having the configuration of FIG. 1, an embodiment limiting the number of the second wiping operations will be described. First, a procedure of a wiping maintenance according to the present embodiment will be described with reference to a flowchart of FIG. 8.

Because the determining of whether recording information of the wiping member end information recording unit is the end in Step S1 and the procedure (Steps S2 to S7) when the present state is not the end state in the Step S1 are similar to the embodiment illustrated in FIG. 3, their descriptions are omitted.

When the present state is the end state in Step S1, it is determined whether the number of recordings of a number-of-times counting unit is equal to or more than a predetermined number of times (Step S31) in the present embodiment. The number of times is to count the number of the second wiping operations by the present blade 12 (Step S32), and is reset by a cleaning operation to be described later or the exchange of the blade 12.

When the number of recordings is less than the determined limit number of times, the second wiping operation is executed by the blade 12 and the number of recordings of the number-of-times counting unit is set to +1 (Step S33). Then, “web end” is displayed on the display panel (Step S34). On the other hand, when the number of recordings is equal to or more than the limit number of times, the end determination is recorded in a second wiping member end information recording unit (Step S35). Then, “unmaintainable” is displayed on the display panel (Step S36), and the liquid discharge apparatus is stopped (Step S37). In the present embodiment, the state where the number of the second wiping operations reaches the limit number of times as described above is the end state of the blade 12 (the second wiping member).

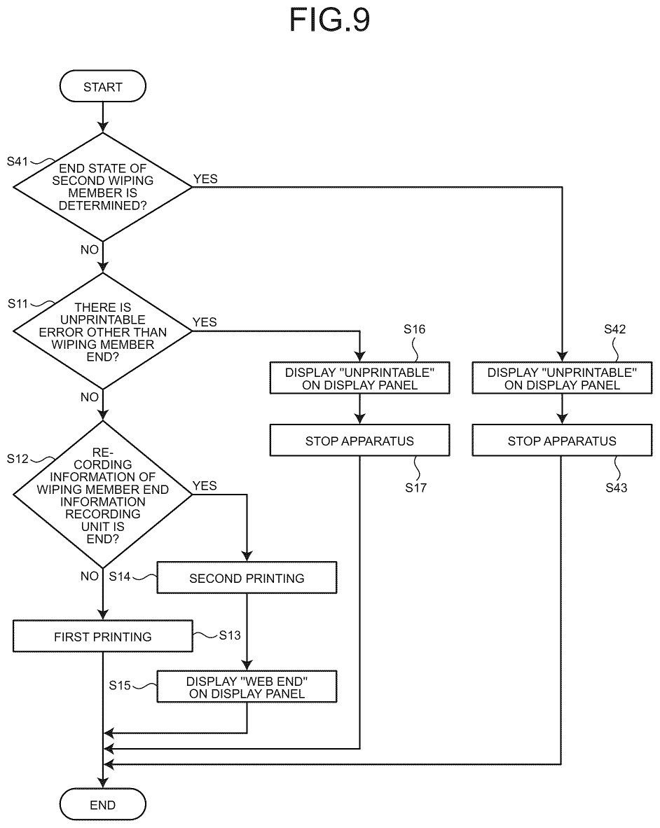

Next, a procedure for the wiping operation during the printing operation according to the present embodiment will be described with reference to a flowchart of FIG. 9. As illustrated in FIG. 9, as a difference from the embodiment illustrated in FIG. 4, the end state of the blade 12 that is the second wiping member is determined during printing (Step S41). Then, when the state of the blade 12 is the end state, “unprintable” is displayed on the display panel (Step S42), and the liquid discharge apparatus is stopped (Step S43). When the state of the blade 12 is not the end state in Step S41, the printing operation is performed by the same procedure as the embodiment illustrated in FIG. 4.

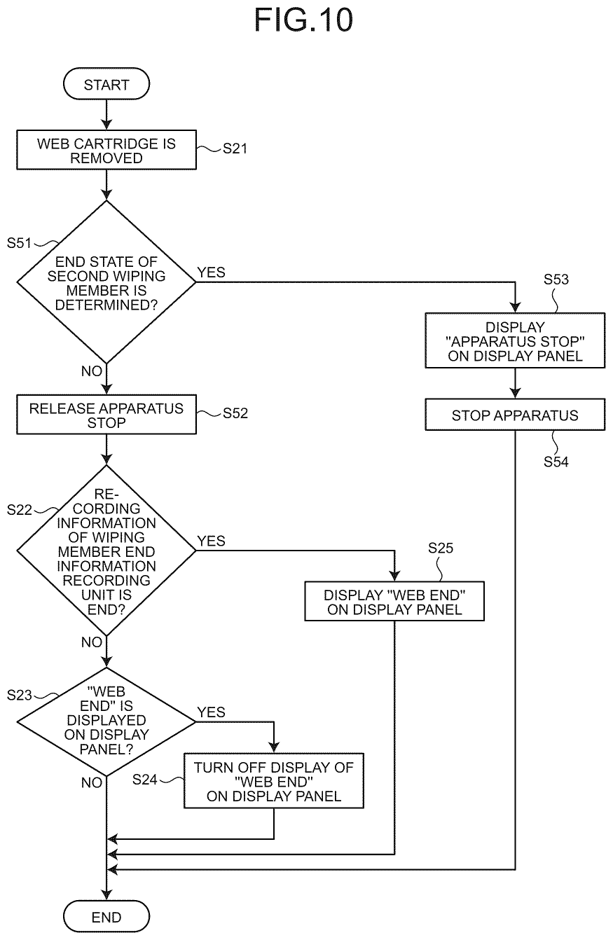

Next, a determination procedure when the web cartridge 2 is exchanged in the present embodiment will be described with reference to a flowchart of FIG. 10. As illustrated in FIG. 10, as a difference from the embodiment of FIG. 5, when the web cartridge 2 is exchanged, the end state of the blade 12 that is the second wiping member is determined (Step S51). Then, when the state of the blade 12 is the end state, “apparatus stop” is displayed on the display panel (Step S53), and the liquid discharge apparatus is stopped (Step S54). On the other hand, when the state of the blade 12 is not the end state in Step S41, the display on the display panel is performed by the same procedure as the embodiment of FIG. 5 after releasing the stopped state of the liquid discharge apparatus (Step S52).

Note that, because the present embodiment has the configuration that the blade 12 is integrated into the web cartridge 2, when the state of the blade 12 is the end state, furthermore, when the number of the second wiping operations by the blade 12 is equal to or more than one, the state of the web 11 is also the end state. For this reason, like Steps S41 to S43 of FIG. 9 or Steps S51, S53, and S54 of FIG. 10, the apparatus is stopped when the state of the blade 12 is the end state. However, when the blade 12 is separately provided, in Step S41 or Step S51, the end states of both of the web 11 and the blade 12 are determined, and the procedure proceeds to Step S42 or Step S53 only when both are in the end state. In this regard, the same applies to Step S41 and Step S51 of embodiments to be described later.

In the present embodiment as described above, a limit is set on the number of the second wiping operations by the blade 12. Ink etc. become deposited on the blade 12 by the repeated use as described above, and thus there is a problem of leading to the poor discharge of the liquid discharge heads. On the contrary, by limiting the number of the second wiping operations by the blade 12 like the present embodiment, such the poor discharge can be prevented from occurring. Moreover, compared to the wiping device 1 having the configuration including only the windable first wiping member without providing the blade 12, a time until the wiping maintenance is not longer possible and the liquid discharge apparatus is stopped can be extended. In other words, the wiping device 1 including the windable web 11 can increase the continuity of the wiping operation.

Moreover, when it is determined that the state of the blade 12 is the end state in Step S31 of FIG. 8, Step S41 of FIG. 9, and Step S51 of FIG. 10, it is possible to make the display panel display “please perform the blade cleaning”. Then, the end state of the blade 12 is released by the panel operation after the operator cleans the blade, and the number of recordings of the number-of-times counting unit can be reset (namely, be set to zero). Specifically, after “please perform the blade cleaning”, the display called “has the blade been cleaned?” is performed. Then, the operator selects the YES button after cleaning the blade 12, and thus the end state of the blade 12 is released and the number of recordings of the number-of-times counting unit can be reset, namely, can be set to zero.

For example, by cleaning the blade 12 through contacting the blade with a stick-shaped cleaning tool, cleaning the blade by cleaning liquid, or exchanging the blade 12 as the cleaning of the blade 12, the number of recordings may be reset.

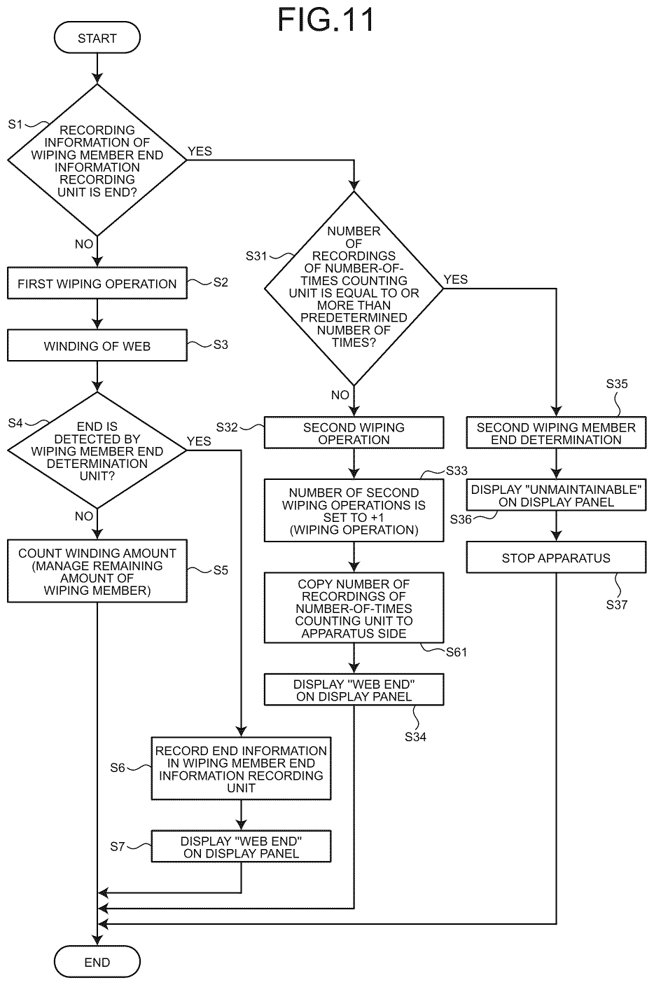

In an embodiment described hereinafter, when exchanging the web cartridge 2, the first wiping operation is executed in accordance with the state of the nozzle surface 50a. First, in the wiping maintenance according to the present embodiment, as illustrated in FIG. 11, a difference from FIG. 8 is to copy the number of recordings of the number-of-times counting unit to the control unit of the liquid discharge apparatus after the second wiping operation (Step S61).

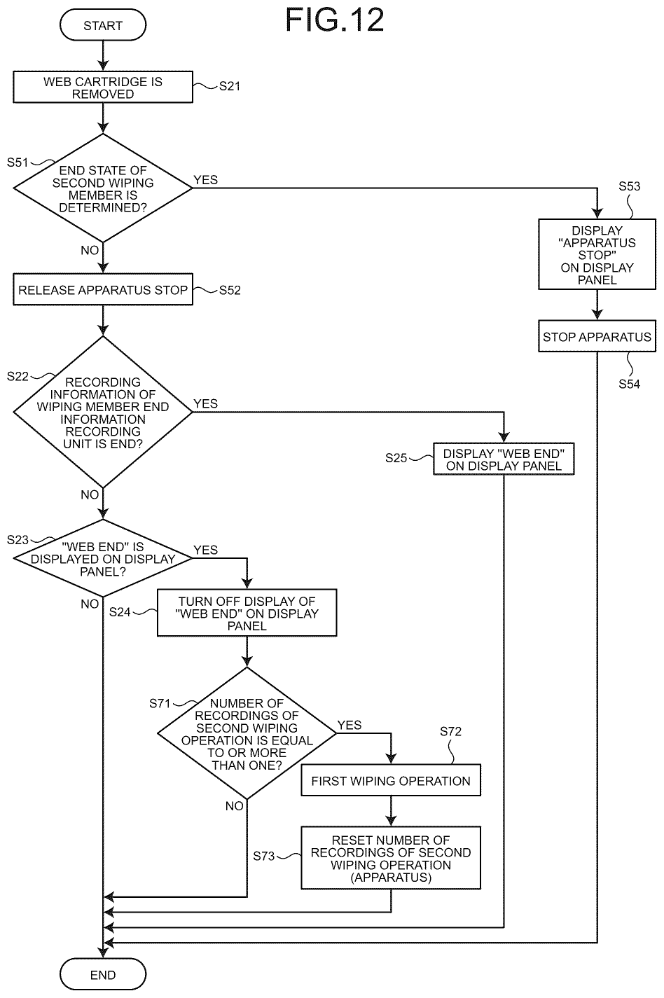

When the web cartridge 2 is exchanged, and when the end determination of the blade 12 that is the second wiping member is not performed in Step S51, the end determination of the web 11 that is the first wiping member is not performed in Step S22, and “web end” is displayed in Step S23, as illustrated in FIG. 12, the display of “web end” on the display panel is turned off (Step S24) and then the procedure proceeds to Step S71. In this case, the web 11 of the web cartridge 2 before the exchange reaches the end state, and thus the second wiping operation may be performed. For this reason, whether the number of recordings is equal to or more than one is determined with reference to the number of recordings of the second wiping operation stored in the liquid discharge apparatus side in Step S71. Then, when the number of recordings is equal to or more than one, the first wiping operation is executed (Step S72), and the number of recordings of the second wiping operation stored in the liquid discharge apparatus side is reset, namely, is set to zero (Step S73).

Note that, when the blade 12 is provided separately from the web cartridge 2, the count of the second wiping operation is reset by cleaning or exchange of the blade 12 without resetting the count of the second wiping operation in Step S73.

By performing the second wiping operation after the web 11 reaches the end state, ink becomes deposited on the blade 12 and the cleanability for the nozzle surface 50a is deteriorated. Thus, ink may also deposit on the nozzle surface 50a not to be a good state. Therefore, like the present embodiment, when exchanging the web cartridge 2, whether the second wiping operation is performed before the exchange is determined, and the first wiping operation is executed when the second wiping operation has been performed. Thus, ink deposited on the nozzle surface 50a is cleaned, and the poor discharge can be prevented. In the above explanation, it has been explained that the first wiping operation is performed when the recorded count is one or more, but the count may be a predetermined number not less than two.

Moreover, in accordance with the number of recordings in Step S71, the frequency of the wiping maintenance by the first wiping operation after that may be changed. In other words, as the number of recordings is larger, ink also may become more deposited on the nozzle surface 50a by the deposition of ink on the blade 12 before the exchange. For this reason, the frequency of the wiping maintenance by the first wiping operation or the third wiping operation after that can be increased in accordance with the increase in the number of recordings. Thus, the number of the wiping operations according to the state of the nozzle surface 50a can be set, and the nozzle surface 50a can be efficiently wiped out. Moreover, the state of the nozzle surface 50a can be preferably maintained, and the poor discharge can be suppressed. Specifically, the frequency of the wiping maintenance after that may be changed by the number of the second wiping operations referred to in Step S71.

In the above explanation, it has been explained that the end state is determined by the number of the second wiping operations, but the end state may be determined by a cumulative operating time of the second wiping operation. In other words, the end state may be determined by whether the operating time of the second wiping operation exceeds a predetermined limit time in Step S31 of FIG. 8, and the used time may be added in Step S33. Moreover, the operating time of the second wiping operation is caused the liquid discharge apparatus side to be recorded in Step S61 of FIG. 11, and the first wiping operation may be executed when the operating time recorded in Step S71 of FIG. 12 is a predetermined time or more. The point that the operating time of the second wiping operation is reset to be zero by exchange or cleaning of the blade 12 is similar.

As described above, the number of times or the operating time of the second wiping operation by the blade 12 (the second wiping member) according to the present embodiment means the cumulative number of usages or the cumulative operating time, of the second wiping operation actually performed by the second wiping member provided in the wiping device 1, from a time point at which cleaning or exchange is finally performed. Note that, the wiping of the nozzle surface 50a by the blade 12 is performed even in the first wiping operation, but because the nozzle surface 50a just after being wiped out by the web 11 is wiped out in this case, the deposition of liquid on the blade 12 is hard to occur. For this reason, the number of times or the operating time of the first wiping operation is not included in the above number of times or operating time.

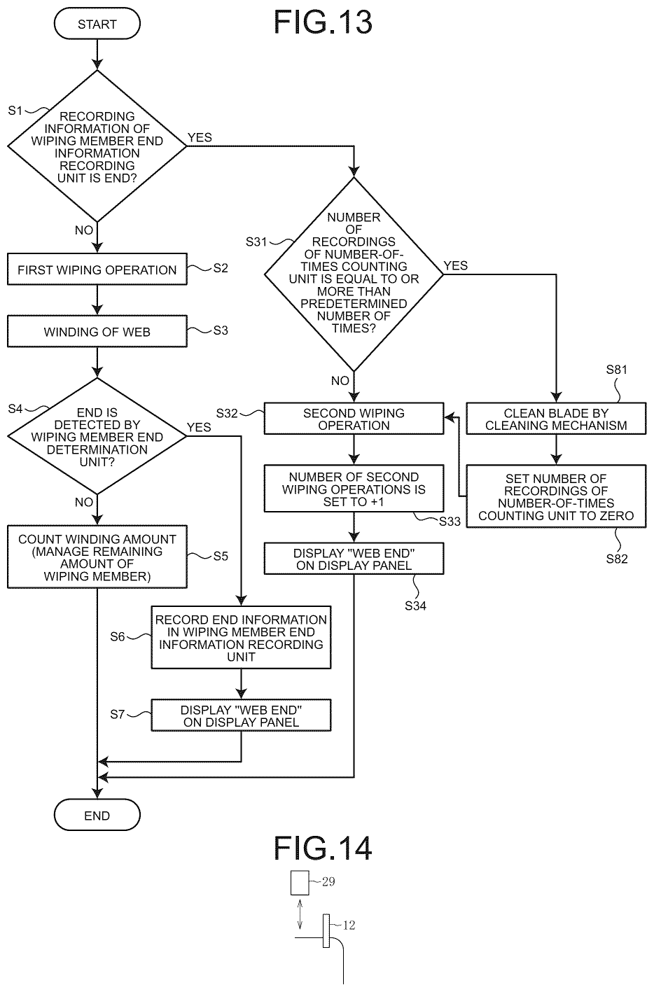

Moreover, in the above explanation, it has been explained that the blade 12 is cleaned by the operator, but a cleaning mechanism that cleans the blade may be arranged in the wiping device or in the liquid discharge apparatus. In this case, as illustrated in FIG. 13, when it is determined that the state of the blade 12 is the end state in Step S31, the cleaning of the blade 12 by the cleaning mechanism is automatically performed (Step S81), and the number of recordings of the number-of-times counting unit is reset (Step S82). After that, the second wiping operation is performed. The present embodiment does not have the determination step of the end state of the second wiping member in Step S41 of FIG. 9 or Step S51 of FIG. 10, and is similar to the flow of FIG. 4 in the printing operation and the flow of FIG. 5 when installing or removing the web cartridge 2. In other words, the continuity of the wiping operation by the wiping device can be further increased without determining the end state of the blade 12.

As illustrated in FIG. 14, a cleaning mechanism 29 is provided in the wiping device 1 to be contactable with and separable from the blade 12. The cleaning mechanism moves up to a position facing the blade 12 during a cleaning operation, and recedes up to a position that does not interfere with the wiping operation in other cases. In the present embodiment, the continuity of the wiping operation can be further increased without stopping the wiping maintenance. Moreover, the apparatus stop does not occur. Furthermore, by reducing the limit number of times of the blade 12 in Step S31 to increase the cleaning frequency by the cleaning mechanism 29, the state of the blade 12 can be better maintained. The cleaning mechanism 29 can be applied to both of a configuration that the blade 12 is provided in the web cartridge 2 and a configuration that the blade 12 is not provided in the web cartridge 2. Moreover, the present embodiment may have a configuration that the blade 12 is made to be contactable with and separable from the cleaning mechanism 29.

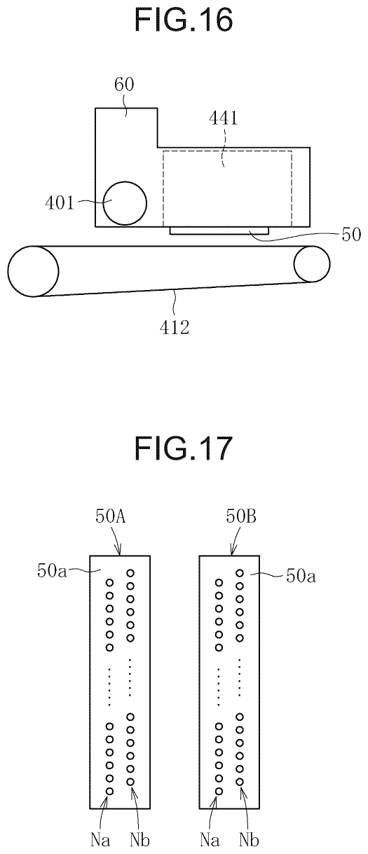

Next, the liquid discharge apparatus mounted with the liquid discharge unit described above will be described with reference to FIGS. 15 and 16. FIG. 15 is a plan explanatory diagram of main parts of the liquid discharge apparatus according to an embodiment. FIG. 16 is a side explanatory diagram of the main parts of the liquid discharge apparatus according to the embodiment.

A liquid discharge apparatus 100 according to the embodiment is a serial type device, and the carriage 60 is adapted to reciprocate in a main-scanning direction by a main-scanning moving mechanism 493. The main-scanning moving mechanism 493 includes a guide member 401, a main-scanning motor 405, a timing belt 408, and the like. The guide member 401 is spanned over a side plate provided on both the left and right sides thereof to movably hold the carriage 60. Then, the carriage 60 is reciprocated in a main-scanning direction X by the main-scanning motor 405 via the timing belt 408 spanned between a drive pulley 406 and a driven pulley 407.

The carriage 60 is mounted with the liquid discharge unit in which the liquid discharge head 50 described above and a head tank 441 for storing ink are integrated. For example, the liquid discharge head 50 described above is adapted to discharge liquid (ink) of each color of yellow (Y), cyan (C), magenta (M), and black (K). Moreover, in the liquid discharge head 50, a nozzle row consisting of a plurality of nozzles described above is arranged in the sub-scanning direction orthogonal to the main-scanning direction to direct the discharge direction downward.

The maintenance unit 26 is provided on one side of the carriage 60 in the main-scanning direction. The maintenance unit 26 includes the cap 25, an empty discharge receiver 27, and the like. Moreover, another empty discharge receiver 28 is provided on the other side of the carriage 60 in the main-scanning direction.

During the printing operation in the liquid discharge apparatus 100 configured as above, paper acting as the recording medium is conveyed from the bottom direction to the top direction of FIG. 15 by a conveying belt 412 of FIG. 16 to move up to a position facing the carriage 60. Therefore, by driving the liquid discharge head 50 in accordance with an image signal while moving the carriage 60 in the main-scanning direction, liquid (ink) is discharged onto the paper that is stopped to form an image. In other words, because the liquid discharge head 50 is included, a high quality image can be stably formed.

For example, as illustrated in FIG. 17, the carriage 60 is mounted with liquid discharge heads 50A and 50B (called “liquid discharge head 50” when there is no distinction). The liquid discharge head 50 discharges, for example, an ink drop of each color of yellow (Y), cyan (C), magenta (M), and black (K). Moreover, in the liquid discharge head 50, a nozzle row consisting of a plurality of nozzles is arranged in the sub-scanning direction orthogonal to the main-scanning direction to direct the drop discharge direction downward. The liquid discharge head 50 includes two nozzle rows Na and Nb of which each has a plurality of arrayed nozzles 4n. One nozzle row Na of the liquid discharge head 50A discharges a droplet of black (K), and the other nozzle row Nb discharges a droplet of cyan (C). One nozzle row Na of the liquid discharge head 50B discharges a droplet of magenta (M), and the other nozzle row Nb discharges a droplet of yellow (Y). In this regard, however, the arrangement of the nozzle rows and the configuration of the liquid discharge heads of the carriage are not limited to the above.

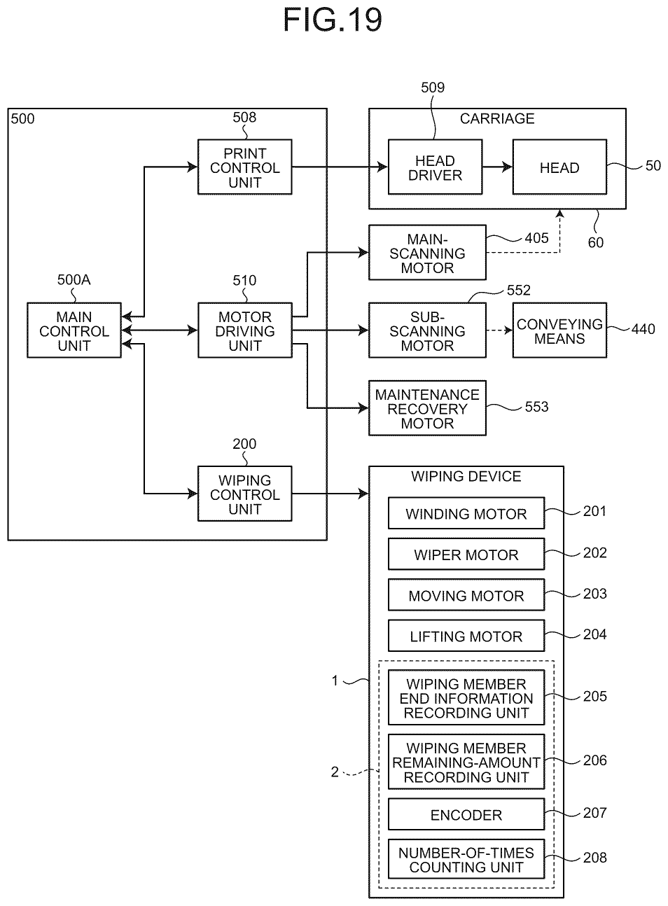

Next, an example of the control unit of the liquid discharge apparatus that includes the wiping mechanism according to the present invention will be described with reference to a control block diagram of FIG. 18 and a functional block diagram of FIG. 19.

A control unit 500 includes a main control unit 500A that includes a CPU (central processing unit) 501 to control the overall device, a ROM (read only memory) 502 to store fixed data such as various types of programs including a program that is executed by the CPU 501, and a RAM (random access memory) 503 to temporarily store image data etc.

Moreover, the control unit 500 includes a nonvolatile memory (NVRAM) 504 that can be rewritten to hold data while the device power supply is being blocked and an ASIC 505 that executes image processing for performing various signal processing, sorting, etc. for image data and processes an input/output signal for controlling the other overall device.

Moreover, the control unit 500 includes a print control unit 508 that includes a data transferring means and a drive signal generating means to control the drive of the liquid discharge head 50 and a head driver (driver IC) 509 that drives the liquid discharge head 50 provided on the carriage 60 side.

Moreover, the control unit 500 includes a motor driving unit 510 that drives a main-scanning motor 405 configured to move and scan the carriage 60, a sub-scanning motor 552 configured to drive a conveying means 440 for conveying paper, and a maintenance recovery motor (pump P) 553 configured to perform the drive of a movement (elevating and lowering) means and a suction means of the cap 25 of the wiping device 1.

Moreover, the control unit 500 includes a wiping control unit 200 that drives the wiping device 1. The wiping control unit 200 includes the wiping member end determination unit configured to determine whether the state of the web 11 that is the first wiping member or the blade 12 that is the second wiping member is the end state. Moreover, according to the embodiment of FIG. 11, the control unit also includes a recording unit that copies and records the number of recordings of the number-of-times counting unit.

Moreover, the control unit 500 includes an I/O unit 513. The I/O unit 513 acquires information from a temperature sensor and various sensor groups 570 mounted on the other device and extracts information required for the control of the device, and uses the information for various controls.

Moreover, a display panel 514 that performs the input and display of information required for the device is connected to the control unit 500.

The control unit 500 includes a host I/F 506 that transmits and receives the data and signal to and from the host side. The host I/F 506 receives the data and signal via a cable or a network from a printer driver 591 side of a host 590 such as “an information processing device such as a personal computer”, an image scanner, and an image capturing device.

Then, the CPU 501 of the control unit 500 reads and analyzes print data inside a receive buffer included in the host I/F 506, and the ASIC 505 performs the required image processing, a sorting process of data, and the like, and transfers the image data from the print control unit 508 to the head driver 509.

The print control unit 508 transfers the above image data as serial data and outputs, to the head driver 509, a transfer clock, a latch signal, a control signal, etc. required for the transfer of the image data, the confirmation of transfer, and the like.

The print control unit 508 includes a DA converter that converts pattern data of a drive pulse stored in the ROM 502 in a digital-to-analog manner and a drive signal generating unit that is configured of a voltage amplifier, a current amplifier, and the like. Then, the print control unit generates a drive waveform consisting of one drive pulse or a plurality of drive pulses, and outputs the drive waveform to the head driver 509.

Based on image data equivalent to one line of the liquid discharge head 50 input serially, the head driver 509 selects drive pulses constituting the drive waveform provided from the print control unit 508 and provides the drive pulses to a pressure generating means of the liquid discharge head 50. Thus, the head driver drives the liquid discharge head 50. At this time, by selecting some or all of pulses constituting the drive waveform or all or some of elements for waveforms forming the pulses, dots having different sizes such as a large drop, a medium drop, and a small drop can be separated.

The wiping device 1 includes a winding motor 201, a wiper motor 202, a moving motor 203, and a lifting motor 204. Moreover, the web cartridge 2 of the wiping device 1 includes a wiping member end information recording unit 205, a wiping member remaining-amount recording unit 206, an encoder 207, and a number-of-times counting unit 208 acting as a second wiping operation recording unit. In this regard, however, the wiping member end information recording unit 205 and the like may be provided on the main body side of the liquid discharge apparatus. Moreover, the arrangement of structural components associated with the control of the wiping can be appropriately changed between the liquid discharge apparatus and the wiping device.

The winding motor 201 is a motor that rotates the winding roller 19 illustrated in FIG. 1 and provides a driving force to perform the winding operation of the web 11. The winding motor 201 is overloaded to become impossible to wind. Thus, the wiping control unit 200 performs the end determination, and the end state of the web 11 is recorded in the wiping member end information recording unit 205.

The wiper motor 202 is a motor that provides a driving force to move the blade 12 up and down. The moving motor 203 is a motor that provides a driving force to move the web cartridge 2 in the wiping direction and the opposite direction by the moving mechanism. The lifting motor 204 is a motor that provides a driving force to drive the cam to move the web cartridge 2 up and down.

The encoder 207 provided in the web cartridge 2 detects the winding amount of the web 11 by the winding motor 201 and transmits the winding amount to the wiping control unit 200. Moreover, the encoder 207 writes the remaining amount of the web 11 to the wiping member remaining-amount recording unit 206. When executing the second wiping operation, the number-of-times counting unit 208 records a number one larger than the recorded number of times. In this regard, however, when not providing a limit of the number of usages of the blade 12 as illustrated in FIG. 8, the number-of-times counting unit 208 may not be provided. Moreover, when the blade 12 is provided separately from the web cartridge 2, the number-of-times counting unit 208 is provided outside the web cartridge 2 so that it is provided in the wiping control unit 200, for example.

Next, another example of the liquid discharge apparatus including the wiping device according to the present embodiment will be described.

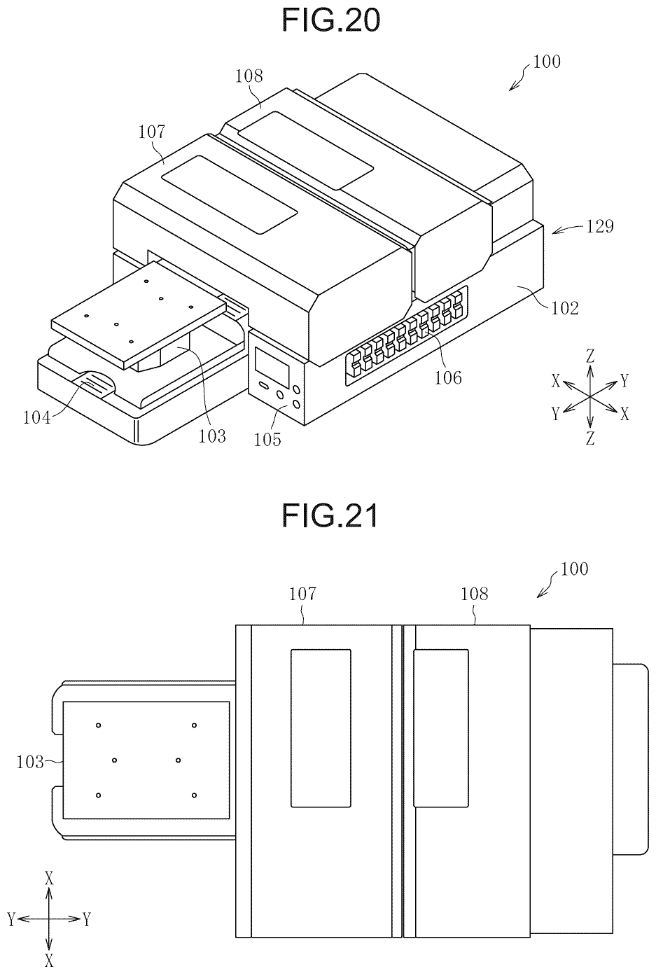

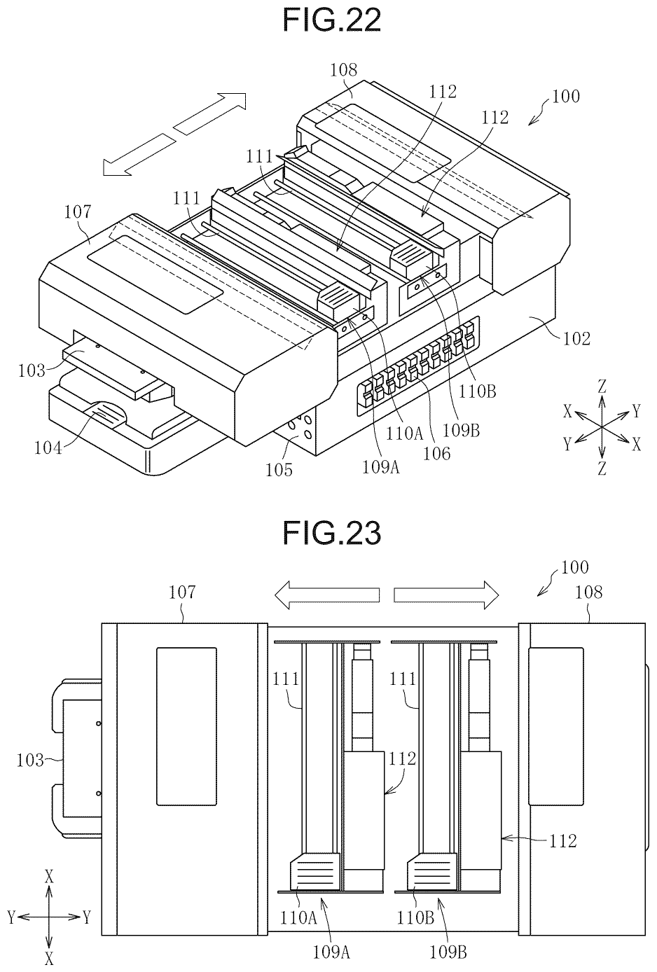

FIGS. 20 and 21 respectively illustrate a perspective view and a plan view of the liquid discharge apparatus 100 whose each cover is closed. Moreover, FIGS. 22 and 23 respectively illustrate a perspective view and a plan view of the liquid discharge apparatus 100 whose each cover is open. In FIG. 20, the direction Y is the front-and-rear direction, the sub-scanning direction, or the recording medium conveyance direction of the liquid discharge apparatus, the direction X is the width direction or the main-scanning direction of the liquid discharge apparatus, and the direction Z is the up-down direction. The direction Y and the direction X are directions parallel to the liquid discharge surface of the recording medium arranged on a stage, but these directions may have a margin of error. The directions Y, X, and Z are directions orthogonal to each other.

As illustrated in FIGS. 20 and 21, the liquid discharge apparatus 100 includes a stage 103 in the front of a housing 102. The stage 103 is provided on a guide rail 104. The guide rail 104 extends in the direction X. A control panel 105 is provided in the front of the housing 102. An ink cartridge 106 is attached to and detached from the side surface of the housing 102. A front cover 107 and a rear cover 108 acting as covers are provided on the upper side of the housing 102.

The upper surface of the stage 103 is a placement surface on which the recording medium is placed, and forms a flat shape. The upper surface of the stage 103 is a surface parallel to the direction Y and the direction X. The stage 103 moves over the guide rail 104, and is provided to be able to reciprocate in both directions of the direction Y. Moreover, the stage 103 is provided to be raised and lowered in the Z direction. Thus, the height of the recording medium arranged on the stage 103 can be adjusted.

The front cover 107 and the rear cover 108 are movably provided in both directions of the direction Y. The state of FIG. 20 where the front cover 107 moves backward and the rear cover 108 moves forward is a state where each cover is closed. On the contrary, the state of FIG. 22 where the front cover 107 moves forward and the rear cover 108 moves backward is a state where each cover is open. As described above, by employing a configuration of opening and closing the front cover 107 and the rear cover 108 by sliding, the occupied area of the liquid discharge apparatus including the opening/closing area of the covers can be reduced compared to a configuration of opening and closing up and down, for example. The front cover 107 and the rear cover 108 have openings on both ends in the front-and-rear direction. In the state where the front cover 107 and the rear cover 108 are closed, the front cover 107 and the rear cover 108 are continuously arranged in the front-rear direction.

As illustrated in FIGS. 22 and 23, a device main body 129 of the liquid discharge apparatus 100 includes the housing 102, liquid discharge units 109A and 109B provided on the housing 102, and the like. In particular, according to the present embodiment, the device main body 129 is a portion other than the front cover 107 and the rear cover 108 of the liquid discharge apparatus 100. The front cover 107 and the rear cover 108 are slidably provided in the Y direction with reference to the device main body 129.

The liquid discharge units inside the liquid discharge apparatus 100 are opened to the outside by opening the front cover 107 and the rear cover 108. By opening the liquid discharge units to the outside, cleaning of the liquid discharge heads and its vicinity or the exchange of the carriage is enabled. Moreover, the front cover 107 and the rear cover 108 are in a closed state when forming an image. Thus, the liquid discharge units 109A and 109B are covered by the front cover 107 or the rear cover 108, and an operating part such as the carriage of the liquid discharge units 109A and 109B becomes inaccessible from the outside. Moreover, by arranging the liquid discharge units 109A and 109B in the closed space inside the front cover 107 or the rear cover 108, ink mist is prevented from scattering around during a liquid discharge operation, and an airflow is circulated inside the front cover 107 or the rear cover 108 by a fan provided in the liquid discharge units 109A and 109B and the generated ink mist is circulated inside the front cover 107 or the rear cover 108 to be able to recover the ink mist.

The liquid discharge apparatus 100 according to the present embodiment includes the two liquid discharge units 109A and 109B in the direction Y. The liquid discharge unit 109A discharges color ink and white ink. The liquid discharge unit 109B discharges pretreatment liquid. Note that liquid discharged from the liquid discharge units 109A and 109B is not limited to the above, and any liquid of color ink, white ink, and pretreatment liquid may be discharged. Particularly, when the recording medium is fabric, because it is preferable to apply pretreatment liquid before image forming by ink, it is preferable that one of the liquid discharge units discharges pretreatment liquid.

Because the liquid discharge units 109A and 109B have the same configuration, the liquid discharge unit 109A will be described below. The liquid discharge unit 109A includes a carriage 110A, a guide rod 111, and an electrical part 112 consisting of a board, an electrical cover, and the like. A position facing the carriage 110A or a carriage 110B in the direction Y is a liquid discharge position where liquid is discharged on the recording medium on the stage 103. The liquid discharge units 109A and 109B or the carriages 110A and 110B are simply referred to as the liquid discharge unit 109 or the carriage 110.

The guide rod 111 extends in the main-scanning direction. The carriage 110 is movably provided along the guide rod 111 in the main-scanning direction. The carriage 110 includes the plurality of liquid discharge heads.

For the above liquid discharge heads, a process of forming an image on the recording medium will be described.

First, the recording medium is placed on the stage 103 and is conveyed on the guide rail 104. Then, the recording medium is conveyed up to the rear side of the liquid discharge apparatus, and is applied with pretreatment liquid by the liquid discharge unit 109B. Specifically, while moving the carriage 110B in the main-scanning direction along the guide rod 111, pretreatment liquid is applied on the recording medium over the main-scanning direction from the nozzles provided in the liquid discharge heads. By repeatedly performing this operation at each position of the sub-scanning direction, the pretreatment liquid is applied on the recording medium. After that, the stage 103 is moved forward, and each color ink is discharged on the recording medium by the liquid discharge unit 109A in the similar method. When performing white printing on the recording medium, after first discharging white ink by the liquid discharge unit 109A, for example, the stage 103 is again moved up to the rear side of the liquid discharge unit 109A, and colored ink is discharged on the recording medium by the liquid discharge unit 109A. Thus, an image can be formed on the recording medium.

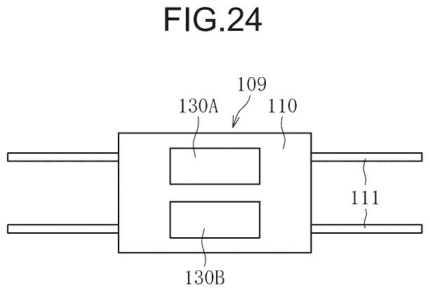

Moreover, as illustrated in FIG. 24, the liquid discharge apparatus may have a configuration that the carriage 110 includes a plurality of liquid discharge head units 130A (rear side of device) and 130B (front side of device). In this case, for example, pretreatment liquid is discharged by the liquid discharge head unit 130A, and white or colored ink is discharged by the liquid discharge head unit 130B.

The above wiping device can be provided in these liquid discharge apparatuses. Thus, with the configuration including the windable wiping member, the continuity of the wiping operation can be increased.

The liquid discharge apparatus described above illustrates merely one embodiment, and thus the liquid discharge apparatus is not limited to this and may have the following configuration. In other words, “liquid discharge apparatus” means an apparatus that includes a liquid discharge head or a liquid discharge unit and drives the liquid discharge head to discharge liquid. Moreover, the liquid discharge apparatus includes not only a device that can discharge liquid onto an object to which liquid can be attached but also a device that can discharge liquid into air or liquid.

The “liquid discharge apparatus” can also include a means related to the feeding, conveyance, or paper ejection of an object to which liquid can be attached, the others, a pretreatment device, an aftertreatment device, and the like. For example, the “liquid discharge apparatus” includes an image forming device configured to discharge ink to form an image on paper and a solid modeling device (three-dimensional modeling device) configured to discharge modeling liquid on a powder layer formed by layering powder to mold a solid modeling object (three-dimensional object).

Moreover, the “liquid discharge apparatus” is not limited to a device that visualizes a significant image such as a character and a graphic by the discharged liquid. For example, the liquid discharge apparatus also includes a device that forms a pattern etc. that have no meaning in itself and a device that molds a three dimensional image. The “object to which liquid can be attached” means an object to which liquid can be attached at least temporarily to adhere, to penetrate, or the like. As a specific example, the object includes a recording medium such as “paper, recording paper, data sheet, film, and cloth”, an electronic component such as “an electronic board and a piezoelectric element”, and a medium such as “a powder layer, an organ model, and a test cell”. Unless otherwise limited, the object includes all objects to which liquid is attached.

The material of the “object to which liquid can be attached” may include one to which liquid is attached even temporarily, such as paper, thread, fiber, fabric, leather, metal, plastic, glass, wood, and ceramics. Moreover, the “liquid” also includes ink, treatment liquid, DNA sample, resist, pattern material, binder, modeling liquid, or solution, dispersion liquid, etc. including amino acid, protein, and calcium.

The “liquid discharge apparatus” further includes a device in which a liquid discharge head and an object to which liquid can be attached are relatively moved, a serial type device in which a liquid discharge head is moved, for example, a line type device in which a liquid discharge head is not moved, and the like.

Furthermore, the “liquid discharge apparatus” includes a treatment liquid coating applicator that discharges treatment liquid on paper to apply the treatment liquid onto the surface of the paper for the purpose of reforming the surface of the paper, an injection granulation device that ejects via a nozzle composition liquid in which raw material is dispersed in solution to granulate particulates of the raw material, and the like.

Herein, the “liquid discharge unit” is a unit obtained by integrating a mechanism and a functional part including a wiping device with a liquid discharge head, and is the collective of parts associated with the discharge of liquid. The configuration of the liquid discharge unit includes ones illustrated in the embodiments, one obtained by combining at least one of a head tank, a carriage, a supply mechanism, a cleaning liquid coating mechanism, and a main-scanning moving mechanism with a liquid discharge head, and the like. The “integration” includes, for example, a case where a liquid discharge head and “a functional part and a mechanism” are fixed to each other by fastening, adhesion, engagement, etc., and a case where one is held to be movable with reference to the other. Moreover, a liquid discharge head and “a functional part and a mechanism” may be configured detachably each other.

The liquid discharge unit can have the following configuration as an example. For example, the liquid discharge unit may be a unit in which a liquid discharge head and a wiping device are integrated, a unit in which a liquid discharge head and a head tank are integrated, and a unit in which a liquid discharge head and a head tank are integrated by connecting them to each other by a tube etc. Furthermore, a unit including a filter can be added between the head tank and the liquid discharge head of these liquid discharge units.

The liquid discharge unit may be a unit in which a liquid discharge head and a carriage are integrated. The liquid discharge unit may be a unit in which a liquid discharge head is movably held in a guide member constituting a portion of a scanning moving mechanism to integrate the liquid discharge head and the scanning moving mechanism. Moreover, as illustrated in FIG. 16, the liquid discharge unit may be a unit in which a liquid discharge head, a carriage, and a main-scanning moving mechanism are integrated.

Furthermore, the liquid discharge unit may be a unit in which a cap that is a portion of a maintenance recovery mechanism is fixed to a carriage to which a liquid discharge head is attached to integrate the liquid discharge head, the carriage, and a wiping mechanism.

Furthermore, the liquid discharge unit may be a unit in which a tube is connected to a liquid discharge head to which a head tank or a flow path part is attached to integrate the liquid discharge head and a supply mechanism. Note that the main-scanning moving mechanism also includes a single guide member. Moreover, the supply mechanism includes a single tube and a single loading section.

The present invention has an advantage of increasing the continuity of a wiping operation in a wiping device including a windable wiping member.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

Aspects of the present invention are as follows for example.
<1> A wiping device includes a windable first wiping member and a second wiping member, and the wiping device wipes out a nozzle surface provided on a liquid discharge head and including a plurality of nozzle holes. The wiping device wipes out the nozzle surface by at least the first wiping member when there is a remaining amount of the first wiping member, and wipes out the nozzle surface by the second wiping member when there is not the remaining amount of the first wiping member.
<2> In the wiping device according to <1>, the second wiping member is provided to be exchangeable integrally with the first wiping member.
<3> In the wiping device according to <1> or <2>, assuming that an operation in which a wiping operation by the first wiping member is not performed and a wiping operation by the second wiping member is performed is a second wiping operation, the wiping device does not execute the wiping operation by the second wiping member when a number of the second wiping operations is equal to or more than a predetermined number of times or when an operating time of the second wiping operation is equal to or more than a predetermined time.
<4> In the wiping device according to <3>, the wiping device resets a recorded number of the second wiping operations or a recorded operating time of the second wiping operation by exchanging the second wiping member.
<5> In the wiping device according to <1>, the wiping device includes a cleaning mechanism configured to clean the second wiping member, and assuming that an operation in which a wiping operation by the first wiping member is not performed and a wiping operation by the second wiping member is performed is a second wiping operation, when a number of the second wiping operations is equal to or more than a predetermined number of times or when an operating time of the second wiping operation is equal to or more than a predetermined time, the cleaning mechanism cleans the second wiping member and the wiping device resets a recorded number of the second wiping operations or a recorded operating time of the second wiping operation.
<6> A liquid discharge apparatus includes a wiping device according to any one of <1> to <5> and a liquid discharge head.
<7> In the liquid discharge apparatus according to <6>, the liquid discharge apparatus includes a display unit, and assuming that an operation in which a wiping operation by the first wiping member is not performed and a wiping operation by the second wiping member is performed is a second wiping operation, the liquid discharge apparatus displays a message prompting cleaning of the second wiping member on the display unit when a number of the second wiping operations is equal to or more than a predetermined number of times or when an operating time of the second wiping operation is equal to or more than a predetermined time.
<8> In the liquid discharge apparatus according to <7>, after the display unit displays the message prompting cleaning of the second wiping member, the liquid discharge apparatus resets a recorded number of the second wiping operations or a recorded operating time of the second wiping operation when an end of the cleaning of the second wiping member is input.
<9> In the liquid discharge apparatus according to any one of <6> to <8>, assuming that an operation in which a wiping operation by the first wiping member is not performed and a wiping operation by the second wiping member is performed is a second wiping operation, the liquid discharge apparatus stops the operation when a number of the second wiping operations is equal to or more than a predetermined number of times or when an operating time of the second wiping operation is equal to or more than a predetermined time.
<10> In the liquid discharge apparatus according to any one of <6> to <9>, the liquid discharge apparatus comprises a second wiping operation recording unit configured to record a number of the second wiping operations or an operating time of the second wiping operation, and during exchanging the first wiping member, when the number of the second wiping operations recorded in the second wiping operation recording unit exceeds a predetermined number of times or when the operating time of the second wiping operation exceeds a predetermined time, the liquid discharge apparatus performs the wiping operation of the nozzle surface by at least the first wiping member.
<11> In the liquid discharge apparatus according to any one of <6> to <9>, the liquid discharge apparatus comprises a second wiping operation recording unit configured to record a number of the second wiping operations or an operating time of the second wiping operation, and during exchanging the first wiping member, in accordance with the number of the second wiping operations or the operating time of the second wiping operation recorded in the second wiping operation recording unit, the liquid discharge apparatus changes a frequency of the wiping operation of the nozzle surface by at least the first wiping member after that.

What is claimed is:

1. A wiping device comprising:
a windable first wiping member; and
a second wiping member,
the wiping device wiping out a nozzle surface provided on a liquid discharge head and including a plurality of nozzle holes, wherein
the wiping device wipes out the nozzle surface by at least the first wiping member when there is a remaining amount of the first wiping member, and wipes out the nozzle surface by the second wiping member when there is not the remaining amount of the first wiping member.

2. The wiping device according to claim 1, wherein the second wiping member is provided to be exchangeable integrally with the first wiping member.

3. The wiping device according to claim 1, wherein assuming that an operation in which a wiping operation by the first wiping member is not performed and a wiping operation by the second wiping member is performed is a second wiping operation, the wiping device does not execute the wiping operation by the second wiping member when a number of the second wiping operations is equal to or more than a predetermined number of times or when an operating time of the second wiping operation is equal to or more than a predetermined time.

4. The wiping device according to claim 3, wherein the wiping device resets a recorded number of the second wiping operations or a recorded operating time of the second wiping operation by exchanging the second wiping member.

5. The wiping device according to claim 1, wherein
the wiping device includes a cleaning mechanism configured to clean the second wiping member, and
assuming that an operation in which a wiping operation by the first wiping member is not performed and a wiping operation by the second wiping member is performed is a second wiping operation, when a number of the second wiping operations is equal to or more than a predetermined number of times or when an operating time of the second wiping operation is equal to or more than a predetermined time, the cleaning mechanism cleans the second wiping member and the wiping device resets a recorded number of the second wiping operations or a recorded operating time of the second wiping operation.

6. A liquid discharge apparatus comprising:
a wiping device according to claim 1; and
a liquid discharge head.

7. The liquid discharge apparatus according to claim 6, wherein
the liquid discharge apparatus comprises a display unit, and
assuming that an operation in which a wiping operation by the first wiping member is not performed and a wiping operation by the second wiping member is performed is a second wiping operation, the liquid discharge apparatus displays a message prompting cleaning of the second wiping member on the display unit when a number of the second wiping operations is equal to or more than a predetermined number of times or when an operating time of the second wiping operation is equal to or more than a predetermined time.

8. The liquid discharge apparatus according to claim 7, wherein after the display unit displays the message prompting cleaning of the second wiping member, the liquid discharge apparatus resets a recorded number of the second wiping operations or a recorded operating time of the second wiping operation when an end of the cleaning of the second wiping member is input.

9. The liquid discharge apparatus according to claim 6, wherein assuming that an operation in which a wiping operation by the first wiping member is not performed and a wiping operation by the second wiping member is performed is a second wiping operation, the liquid discharge apparatus stops the operation when a number of the second wiping operations is equal to or more than a predetermined number of times or when an operating time of the second wiping operation is equal to or more than a predetermined time.

10. The liquid discharge apparatus according to claim 6, wherein
the liquid discharge apparatus comprises a second wiping operation recording unit configured to record a number of the second wiping operations or an operating time of the second wiping operation, and
during exchanging the first wiping member, when the number of the second wiping operations recorded in the second wiping operation recording unit exceeds a predetermined number of times or when the operating time of the second wiping operation exceeds a predetermined time, the liquid discharge apparatus performs the wiping operation of the nozzle surface by at least the first wiping member.

11. The liquid discharge apparatus according to claim 6, wherein
the liquid discharge apparatus comprises a second wiping operation recording unit configured to record a number of the second wiping operations or an operating time of the second wiping operation, and
during exchanging the first wiping member, in accordance with the number of the second wiping operations or the operating time of the second wiping operation recorded in the second wiping operation recording unit, the liquid discharge apparatus changes a frequency of the wiping operation of the nozzle surface by at least the first wiping member after that.
